(19) United States
(12) Patent Application Publication
(10) Pub. No.: US 2015/0060617 A1
(43) Pub. Date: Mar. 5, 2015

(54) HANGER STRUCTURE

(71) Applicant: Chieh Yang Pan, Taoyuan (TW)

(72) Inventor: Chieh Yang Pan, Taoyuan (TW)

(21) Appl. No.: 14/013,303

(22) Filed: Aug. 29, 2013

(51) Int. Cl. B60R 1/12; B60R 11/00; B60K 35/00

(52) U.S. Cl. CPC B60R 1/12; B60K 35/00; B60R 11/00; B60K 2350/927; B60K 2350/94; B60R 2001/1284; B60R 2011/0033; B60R 2011/0059; B60R 2011/0071
USPC 248/227.1

(57) ABSTRACT

An improved hanger structure, which is fitted with a U-shaped arched clipper; hooks are set separately at end of two support arms of the clipper and at its opposite flat end; a slot is set separately at the other end of two support arms, into which a tape spring with pretension force is embedded; the hook could drive and pull the tape spring via the hooking rack, such that the hook could be pulled back into the clipper; the present invention is stably supported in a three jaw pattern, so it can be mounted flexibly on the back of the rear-view mirror of various dimensions, meanwhile on-board electronics such as driving recorder, GPS and velometer can be efficiently integrated, allowing to maintain good vision in the vehicle compartment without affecting the driving safety.

### BACKGROUND OF INVENTION

1. Field of the Invention

The present invention relates generally to an improved hanger structure, and more particularly to an innovative one which is incorporated onto the vehicle's rear-view mirror to load the driving electronics and remove the sight obstructions in the process of driving.

2. Description of Related Art

Due to technological progress, there are a variety of mobile tools that can gain an easy access to various real-time information, so such tools as driving recorders, GPS, velometers and integrators with display screens have become an indispensable helper for the customers; according to the habits of customers, such devices are preferably mounted onto the vehicle's windshield, rear-view mirror, and the operating console over the driver's seat for convenient access.

Yet, there is a possibility that more devices could be added into the limited space of the vehicle, but set disorderly around the driver's seat due to lack of optimal arrangements, affecting negatively the mood of the drivers and disturbing their driving vision; so it is an important issue to mount the driving electronics and built-in hanger at optimum location without affecting previous driving vision.

To mount the electronics at optimum location, a special auxiliary hanger is equipped and attached by a sucker to the surface of windshield, allowing to learn easily the driving information; yet, after the rubber sucker is attached onto the glass surface for a certain period of time, the temperature variation arising from thermal expansion and contraction will result in reduced suction force and poorer adhesion, or even local deformation and blistering of the sheathing paper; moreover, when some electronics are mounted between the front windshield and the operating console over the driver's seat, the scope of the driving vision will be further cut down against the driving safety.

### SUMMARY OF THE INVENTION

The primary objective of the present invention is to provide an improved hanger structure, which could be easily loaded onto the vehicle's rear-view mirror, so as to mount the driving electronics and remove the sight obstructions in the process of driving.

The present invention provides an improved hanger structure, which is fitted with a U-shaped arched clipper; hooks are set separately at end of two support arms of the clipper and at its opposite flat end, and a slot is set separately at the other end of two support arms, into which a tape spring with pretension force is embedded; said hook is used to drive and pull the tape spring by a hooking rack, such that the hook can be pulled back into the clipper. As the clipper is supported by three jaws, the present invention can be flexibly mounted onto the back of rear-view mirror of various dimensions, meanwhile on-board electronics such as driving recorder, GPS and velometer can be efficiently integrated, allowing to maintain good vision in the vehicle compartment without affecting the driving safety.

Furthermore, said hooking rack is of arched shape, at both ends of which there are two small hooks and a large hook; and at least a folded portion is set into the hooking rack. At the eternal surface of the flat end of the clipper is a pair of guiding slot that limits the sliding of the hooking rack.

Furthermore, a mating portion is horizontally extended from the clipper on the external surface of the flat end, so driving electronics such as driving recorder, GPS and velometer can be incorporated accordingly.

Furthermore, the mating portion and clipper can be prefabricated, or one end of the mating portion is bolted with the flat end of the clipper.

The structural features and efficacies of the present invention will be more readily understood with reference to the accompanying drawings:

### BRIEF DESCRIPTION OF THE DRAWINGS

FIG. 1: a perspective view of the present invention.

FIG. 2: an assembled and exploded view of the present invention.

FIG. 3: a mating view of the rear-view mirror of the present invention.

FIG. 4: a schematic view that the present invention is incorporated onto the rear-view mission.

FIG. 5: a schematic view that the present invention is incorporated into the interior of the vehicle.

### DETAILED DESCRIPTION OF THE INVENTION

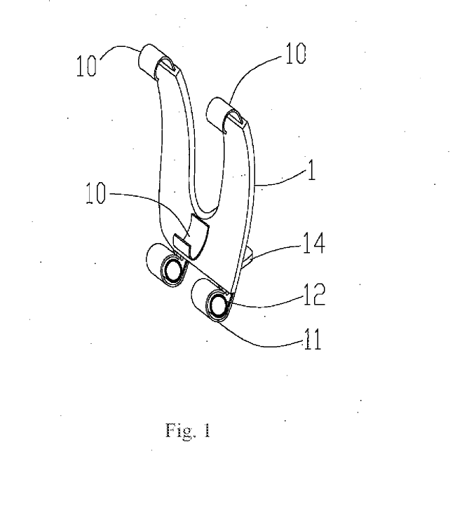

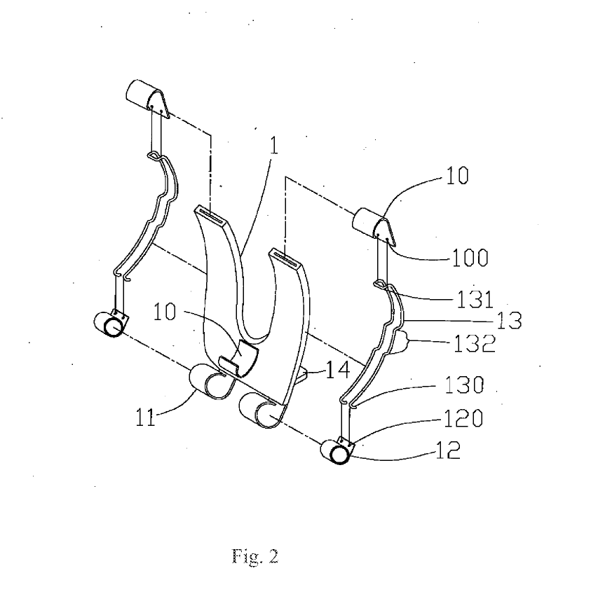

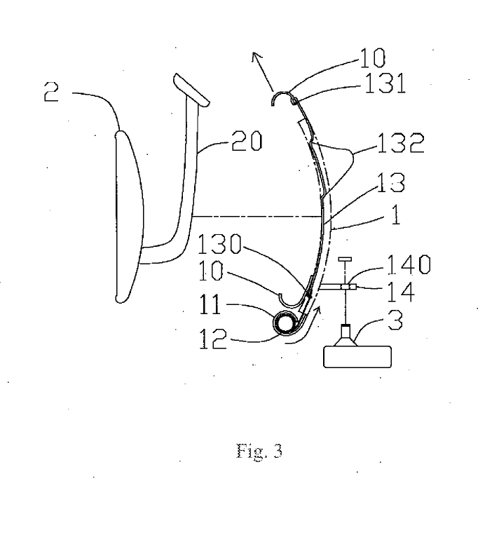

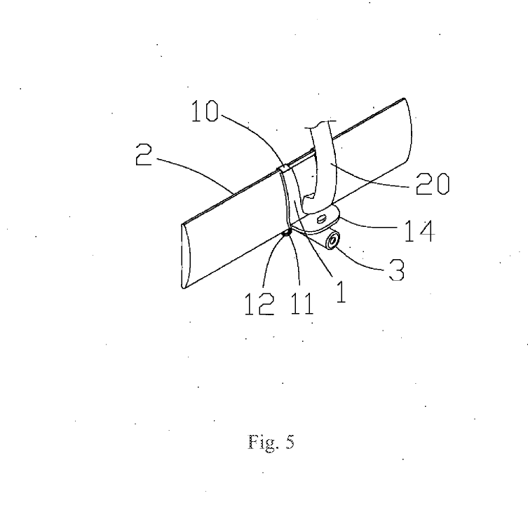

Referring to FIGS. 1-5—schematic views of a preferred embodiment of the present invention, wherein the “improved hanger structure” is of a hanger 1, which is fitted with a U-shaped arched clipper; hooks 10 are set separately at end of two support arms of the clipper and at its opposite flat end; also the hooks are fixed at the flat end, and can be shifted at end of two support arms; a slot 11 is set separately at the other end of two support arms, into which a tape spring 12 with pretension force is embedded; said tape spring 12 is coiled by a thin spring, and two punch holes 120 are exposed at one end surface; one hooked end of the hook 10 at two support arms of the clipper is exposed out of the clipper, and the other end of the hook 10 is fitted with two through-holes 100, allowing for moving flexibly into two supports arms of the clipper; a hooking rack 13 made of fine steel coils is set into the clipper; the hooking rack 13 is available with an open end and two small hooks 130, while the other end is closed to form a large hook 131; the hooking rack 13 is designed into an arched shape between two small hooks 130 and large hook 131, while at least a folded portion 132 is arranged; these two small hooks 130 are hooked securely into two punch holes 120 of the tape spring 12, and the large hook 131 is hooked securely on two through-holes 100 of the hook 10, such that the hook 10 could drive and pull the tape spring 12 via the hooking rack 13; the tape spring 12 with pretension force could pull back the hook 10 into the clipper; the folded portion 132 permits the hooking rack 13 to generate local stress effect, avoiding the deformation and straightening of arched hooking rack 13 against the clamping force between the hooks 10; this enables to extend the service life of the hooking rack 13; referring to FIG. 5, the external surface of the flat end of the clipper has a pair of guiding slot 15 that limits the sliding of the hooking rack 13; a mating portion 14 is horizontally extended from the clipper on the external surface of the flat end; and the mating portion 14 and the clipper could be prefabricated, or one end of the mating portion 14 is bolted with the flat end of the clipper. Besides, an opening 140 or a universal adapter pattern is set at the mating portion 14, such that the hanger 1 of the present invention could be incorporated onto the vehicle's rear-view mirror 2, meanwhile the driving electronics 3 such as driving recorder, GPS and velometer can be efficiently integrated.

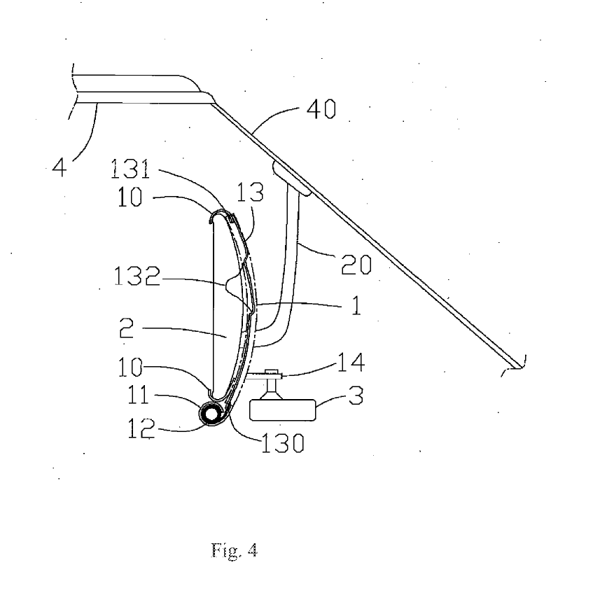

Referring to FIGS. 4, 5, the hanger 1 of the present invention could be incorporated onto rear-view mirror 2 within the vehicle compartment 4; said rear-view mirror 2 is fixed onto the windshield 40 by a strut 20; said hanger 1 allows the hook 10 already fixed on the flat end to be abutted onto the lower edge of the rear-view mirror 2, and then pull out the hook 10 from the end of both support arms; so the hanger 1 is clamped on the back of the rear-view mirror 2; the mating portion 14 is incorporated into the opening 140 of the driving electronics 3 and then bolted securely. In the practice, the hooks 10 are implemented in a three-jaw pattern by a fixed and two movable hooks, and can be clamped tightly onto the flange of the rear-view mirror 2 of various dimensions

To sum up, the arched hanger of the present invention and the common driving electronics can be jointly clamped onto the rear-view mirror for an optimum vision, and also buried into the rear-view mirror without affecting the driving vision, without affecting the arrangement of the vehicle compartment and disturbing their driving vision; moreover, an integrated housing could be fabricated and hung onto the back of the rear-view mirror, enabling optimal detection vision and driving safety; hence, the present invention shows excellent industrial benefits and value as an innovative product not yet publicly available complying with the spirit of new patents, so the patent claims are made hereto.

Although the invention has been explained in relation to its preferred embodiment, it is to be understood that many other possible modifications and variations can be made without departing from the spirit and scope of the invention as hereinafter claimed.

1. An improved hanger structure, which is fitted with a U-shaped arched clipper; hooks are set separately at end of two support arms of the clipper and at its opposite flat end; a slot is set separately at the other end of two support arms, into which a tape spring with pretension force is embedded; the hook could drive and pull the tape spring via the hooking rack, such that the hook could be pulled back into the clipper, and clamped tightly on the back of the rear-view mirror of various dimensions; moreover, a mating portion is horizontally extended from the clipper on the external surface of the flat end; and the mating portion is used for mated with a driving electronics.

2. The improved hanger structure as claimed in claim 1, wherein said hooks are fixed at the flat end, and can be shifted at end of two support arms.

3. The improved hanger structure as claimed in claim 1, wherein said tape spring is coiled by a thin spring; two punch holes are exposed at one end surface of the tape spring, and the other end of the hook is fitted with two through-holes, allowing for moving flexibly into two supports arms of the clipper.

4. The improved hanger structure as claimed in claim 3, wherein said hooking rack made of fine steel coils is set into the clipper; the hooking rack is available with an open end and two small hooks, while the other end is closed to form a large hook; at least a folded portion is arranged; these two small hooks are hooked securely into two punch holes of the tape spring, and the large hook is hooked securely on two through-holes of the hook, such that the hook could drive and pull the tape spring via the hooking rack, such that the tape spring with pretension force could pull back the hook into the clipper.

5. The improved hanger structure as claimed in claim 1, wherein said mating portion is provided with an opening pattern, which can be bolted with the driving electronics.

6. The improved hanger structure as claimed in claim 1, wherein said mating portion is provided with a universal adapter pattern, which can be coupled with the driving electronics.

7. The improved hanger structure as claimed in claim 1, wherein said driving electronics refer to a driving recorder, GPS and velometer.
